(19) United States
(12) Patent Application Publication
(10) Pub. No.: US 2026/0008534 A1
(43) Pub. Date: Jan. 8, 2026

(54) Jack Plate Assembly

(71) Applicant: T-H Marine Supplies, LLC, Huntsville, AL (US)

(72) Inventors: Eric Cook, Huntsville, AL (US); Greg Buie, Huntsville, AL (US); Eric Griggs, Huntsville, AL (US)

(73) Assignee: T-H Marine Supplies, LLC, Huntsville, AL (US)

(21) Appl. No.: 18/765,895

(22) Filed: Jul. 8, 2024

(51) Int. Cl. B63H 20/10; F16M 5/00

(52) U.S. Cl. CPC B63H 20/106; F16M 5/00

(57) ABSTRACT

A jack plate assembly is disclosed herein. The jack plate assembly includes a unitary main frame piece. The unitary main frame includes two wings and a transom segment between the two wings for attaching to the transom of a boat. The two wings each include a channel for inserting a slider rod which is attached to each vertical side of a motor plate configured for attaching a motor. The motor plate can include two stop blocks and the two wings can each include a stop on the inside such that the stop blocks are positioned above the stops to prevent the motor plate from disengaging from the unitary main frame in a downward direction when the stop blocks contact the stops.

### TECHNICAL FIELD

The present disclosure generally relates to jack plates, and more particularly to an assembly for a unitary jack plate with a stopping mechanism.

### BACKGROUND

The present disclosure generally relates to jack plates, and more particularly to an assembly for a jack plate with a mechanism to restrict the vertical movement of an outboard motor attached to the jack plate. A jack plate can be attached to the transom of a boat to add distance between the outboard motor and the transom of the boat. As water goes under the hull of the boat and hits the propeller of the motor, there is water turbulence. By moving the entire outboard motor further away from the back of the boat via the jack plate, the water turbulence decreases when the water hits the propeller, thereby increasing performance. A jack plate also allows a boater to move the entire engine up and down so the boat can go in shallow or deep waters, or to otherwise optimize performance.

Traditional jack plate assemblies include several pieces affixed together, such as with bolts and screws holding together a transom plate between two spacing brackets. An outboard motor can be attached to a separate motor plate component of the jack plate assembly, and bearings in the spacing brackets can be connected to the motor plate. These jack plate assemblies use a mechanism for stopping the motor from falling downwards and out of the jack plate comprising bearings with raised edges in the spacing brackets so that the bearings cannot slide out of the spacing brackets. For example, the bearings have a lip or enlarged area on the top so that if the hydraulics fail and the motor plate and bearings begin to slide in the spacing brackets, there is an enlarged end at the top of the bearings so that the entire motor will not slide out of the bottom of the jack plate.

However, a jack plate with many separate components, such as a separate transom bracket and spacing brackets, results in a jack plate with many pieces that can fail, as well as significant assembly time in the field. An improvement to a jack plate is needed that includes less pieces and an improved stopping mechanism.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure generally relates to an assembly for a unitary jack plate with a stopping mechanism. Traditionally, jack plates are comprised of several pieces, such as a transom plate and two spacing brackets, attached to each other, such as with bolts and screws, so that the transom plate is secured between the two spacing brackets. However, a jack plate with many separate components results in a jack plate with many pieces that can fail, as well as significant assembly time in the field. The jack plate of the present disclosure can be a unitary main frame piece, such as a single metal cast piece, which includes two wings and a transom segment between the two wings. The transom segment can be attached to a boat transom while each wing can include channels shaped for a slider rod. The slider rods can be affixed to a motor plate, which can have a motor affixed thereto, and inserted into channels formed in each wing. Each wing can include one or more stops that protrude from the inside of the wing towards the opposite wing, and the motor plate can include a stop block protruding from each side that are positioned between upper and lower stops on the insides of the wings. This stopping mechanism prevents the motor plate, and thus the motor, from disengaging from the unitary main frame in a downward and an upward direction when the stop blocks contact the stops. As a result, less components are needed for the jack plate, allowing for easier assembly and a reduced likelihood of components of the jack plate failing. The improved stopping mechanism(s) can be used with the unitary style discussed herein, as well as used with the other traditional, multi-piece jack plate designs.

One aspect of the disclosure is a jack plate. The jack plate may include a main frame comprising a left wing, a right wing, and a transom segment between the left wing and the right wing, wherein the left wing and the right wing each include a channel configured for inserting a slider rod, and wherein the transom segment is configured to attach to a boat transom. The jack plate may include a motor plate positioned between the left wing and the right wing and configured for attaching a motor. The jack plate may include a first stop block configured to attach to the motor plate and a second stop block configured to attach to the motor plate, wherein the first stop block and the second stop block protrude externally from the motor plate. The jack plate may include a first stop configured to attach inside the left wing and a second stop configured to attach inside the right wing, wherein the first stop protrudes externally and inward from the left wing and the second stop protrudes externally and inward from the right wing, and wherein the first stop is positioned below the first stop block and the second stop is positioned below the second stop block.

Another aspect of the disclosure is another jack plate. The jack plate may include a first stop block attached to a motor plate and a second stop block attached to the motor plate, wherein the first stop block and the second stop block protrude externally from the motor plate. The jack plate may include a first stop attached inside a left wing of the jack plate and a second stop attached inside a right wing of the jack plate, wherein the first stop protrudes externally and inward from the left wing and the second stop protrudes externally and inward from the right wing, and wherein the first stop is positioned below the first stop block and the second stop is positioned below the second stop block.

Another aspect of the disclosure is another jack plate. The jack plate may include a main frame comprising a left wing, a right wing, a transom segment between the left wing and the right wing, and an actuator bracket, wherein the left wing and the right wing each include a C-shaped channel configured for inserting a slider rod, the left wing and the right wing are each configured for a stopping mechanism, the transom segment is configured to attach to a boat transom, and the main frame comprises a single metal piece.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1A is a front view of a jack plate assembly according to an example embodiment of the present disclosure.

FIG. 1B is a rear view of a jack plate assembly according to an example embodiment of the present disclosure.

FIG. 1C is a cross-section view of a jack plate assembly according to an example embodiment of the present disclosure.

FIG. 2A is a front view of a unitary main frame of a jack plate assembly according to an example embodiment of the present disclosure.

FIG. 2B is a rear view of a unitary main frame of a jack plate assembly according to an example embodiment of the present disclosure.

FIG. 3A is a front view of a motor plate of a jack plate assembly according to an example embodiment of the present disclosure.

FIG. 3B is a rear view of a motor plate of a jack plate assembly according to an example embodiment of the present disclosure.

### DETAILED DESCRIPTION

Reference will now be made in detail to exemplary embodiments of the disclosure, some aspects of which are illustrated in the accompanying drawings.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements(1)-(m)” where m is a number that may be the same or may be a different number than n.

The present disclosure is directed to an assembly for a unitary jack plate with a stopping mechanism. The jack plate of the present disclosure can include a unitary main frame piece, such as a single metal cast piece, which is made of two wings and a transom segment between the two wings. The transom segment can be attached to a boat transom while each wing can include channels shaped for slider rods that are affixed to a motor plate, which can have an outboard motor affixed thereto. Each wing can include one or more stops that protrude from the inside of the wing towards the opposite wing, and the motor plate can include a stop block protruding from each side opposite the motor which are positioned between upper and lower stops on the insides of the wings. This stopping mechanism is a safety feature that prevents the motor plate, and thus the motor, from disengaging from the unitary main frame in a downward and an upward direction when the stop blocks contact the stops.

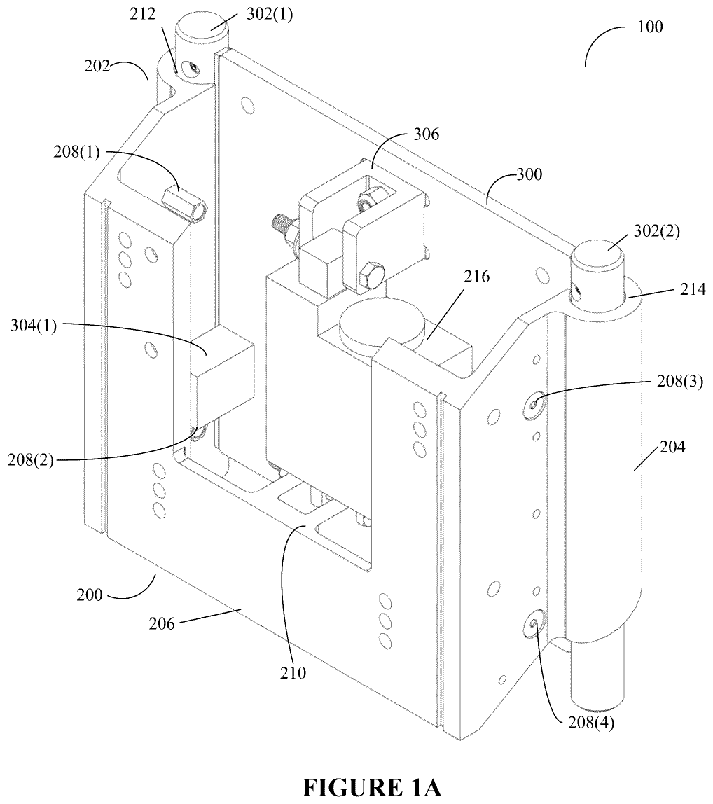

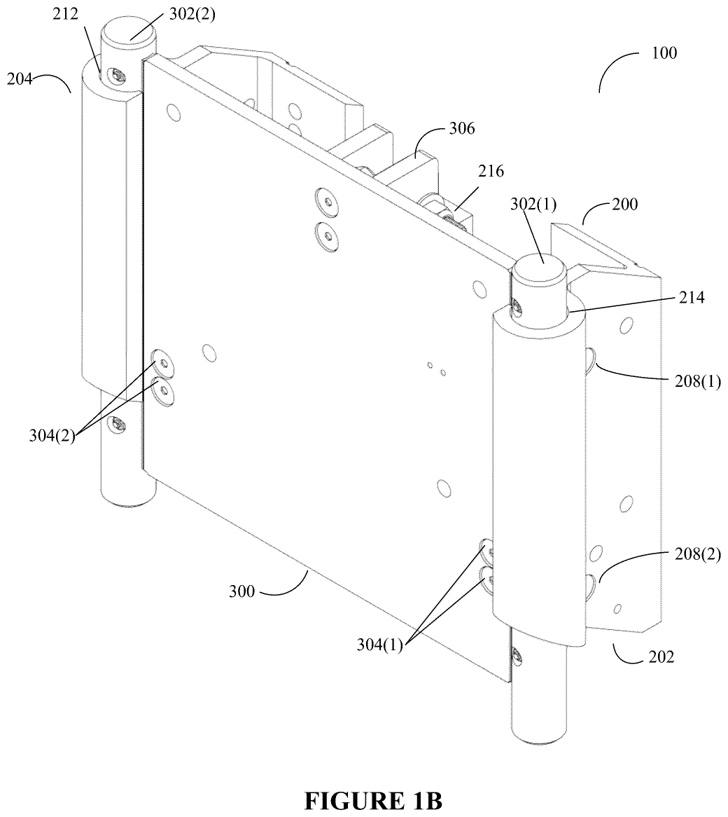

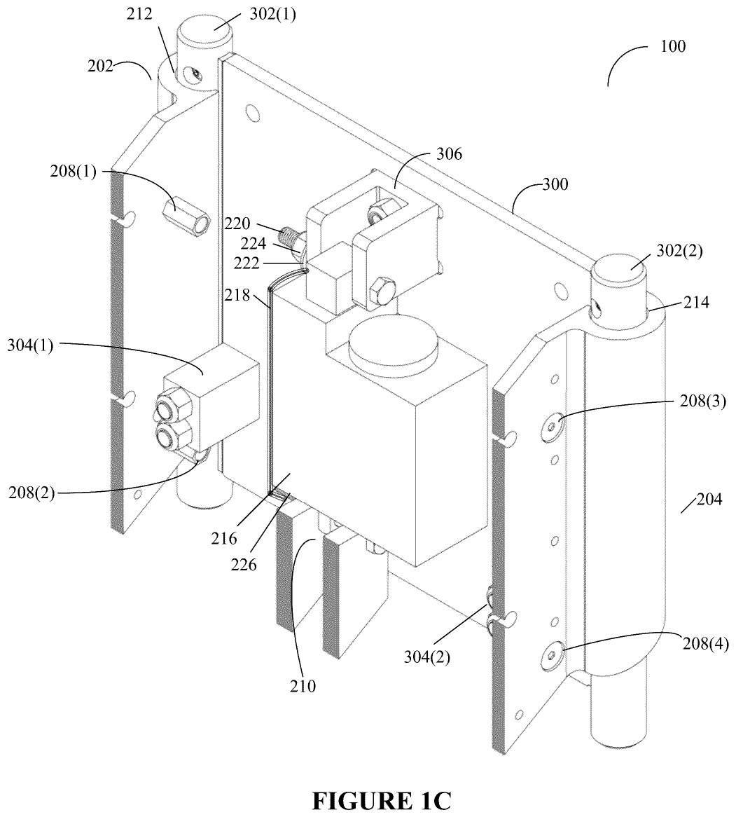

FIG. 1A is a front view of a jack plate assembly according to an example embodiment of the present disclosure. In the example of FIG. 1A, a jack plate assembly 100 includes a main frame 200 and a motor plate 300. The main frame 200 can include a left wing 202 and a right wing 204, with a transom segment 206 between the left wing 202 and the right wing 204. In the preferred embodiment, the main frame 200 is a unitary main frame such that one piece of material comprises the left wing 202, the right wing 204, and the transom segment 206, such as a single metal cast piece or a single extruded piece of aluminum. As a single, unitary component, the main frame 200 does not have a recess in the left wing 202 or the right wing 204 to receive a corresponding part of the transom segment 206 and there are no keys to arrange a fit between the wings and the transom segment. The transom segment 206 of the main frame 200 can be connected to a boat transom (e.g., with bolts inserted through holes on the transom segment 206 to secure the main frame 200 to the boat) and an outboard motor can be attached to the back of the motor plate 300. The jack plate setback, which is generally the distance from the transom segment 206 (i.e., where the jack plate mounts on the boat) to the motor plate 300 (i.e., where the jack plate mounts to the outboard motor), can range from one inch to twelve inches, such as a four inch, six inch, or ten inch setback as non-limiting examples.

The left wing 202 of the main frame 200 can include a channel 212 formed in the main frame 200 for inserting a first slider rod 302(1) and the right wing 204 of the main frame 200 can include a channel 214 for inserting a second slider rod 302(2) (collectively, slider rods 302). The channels for the slider rods 302 face away from the back of the boat (i.e., away from the transom segment 206 when the main frame 200 is attached to a boat transom). The left wing 202 channel 212 and the right wing 204 channel 214 can each have a C-shape so that the motor plate 300 that is inserted into the slider rods 302 is positioned between the left wing 202 and the right wing 204 and opposite from the transom segment 206 when the slider rods 302 are inserted into the wings. The slider rods 302 can each be cylindrical in shape with a circumference less than the circumference of the channels and made of a material that allows the slider rods 302 to move vertically within the channels of the left wing 202 and the right wing 204. The slider rods 302 can be cylindrical rods with a singular circumference throughout such that there is no ledge or lip at the tops and/or bottoms of the slider rods 302. The slider rods 302 can each include a vertical recess on one side to allow the slider rods 302 to fit over the sides of the motor plate 300, such as a groove machined into each of the slider rods 302 where the motor plate 300 can be inserted. The sides of the motor plate 300 can be inserted into each of the slider rods 302 such that the motor plate 300 is between the left wing 202 and the right wing 204 when the slider rods 302 are inserted into the channels of the left wing 202 and the right wing 204. The motor plate 300 can have a left edge and a right edge that each have a vertical recess to allow the left and right edges of the motor plate 300 to be inserted into the slider rods 302. In some embodiments, the slider rods 302 can each include a vertical recess on one side to allow the slider rods 302 to fit over the sides of the motor plate 300, and the motor plate 300 and slider rods 302 can have holes that line up to be bolted together with bolts inserted through one side of the slider rods 302 through the motor plate 300 to the other side of the slider rods 302 and secured with a nut to secure the motor plate 300 in the slider rods 302.

The jack plate assembly 100 can include a stopping mechanism comprising stop blocks and stops, instead of bearings (e.g., slider rods 302) with raised edges, to stop the motor plate 300 from sliding out of the main frame 200. There can be a first stop block 304(1) and a second stop block 304(2) (not illustrated) (collectively, stop blocks 304) attached to the motor plate 300 such that the stop blocks 304 protrude externally from the front of the motor plate 300. In some embodiments, the stop blocks 304 can be rectangular blocks of metal secured to the motor plate 300 with two threaded bolts inserted from holes in the rear of the motor plate 300 through threaded holes in the stop blocks 304 and secured with nuts that have threading that matches the bolts. In some embodiments, the motor plate 300 can be a single piece motor plate, such as a single metal cast piece or a single extruded piece of metal comprising the stop blocks 304 (e.g., the stop blocks 304 are cast as part of the single metal cast piece).

There can be a plurality of stops 208(1)-208(4) (collectively, stops 208) installed on the insides of the wings of the main frame 200 between the transom segment 206 and the channels of the wings. For instance, stop 208(1) and stop 208(2) can be attached to the inside of the left wing 202 and stop 208(3) and stop 208(4) can be attached to the inside of the right wing 204. In embodiments where each of the wings has two stops (e.g., the left wing 202 with stop 208(1) and stop 208(2), and the right wing 204 with stop 208(3) and stop 208(4)), the first stop can be positioned above the second stop such that there is sufficient space between the two stops for the stop blocks 304. Attaching two stops to each of the wings allows the stopping mechanism to prevent the motor plate 300, and thus the motor, from disengaging from the unitary main frame 200 in a downward and an upward direction when the stop blocks 304 contact the stops 208. In some embodiments, there can be one stop on the inside of each wing for a total of two stops, such as stop 208(2) installed inside the left wing 202 and stop 208(4) installed inside the right wing 204. The stops 208 can each be a bolt inserted through a hole on the outside of the wings secured with a nut threaded onto the bolt where the bolt is longer than the thickness of the wings such that the stops 208 (i.e., the bolts) protrude out of the wings and inward towards the motor plate 300. In some embodiments, the nuts securing the bolts that comprise the stops 208 can encompass all of the portion of the bolt and threads that are protruding from the interior of the wings such that the nut acts as the stop. Thus, the stops 208 can be threaded bolts screwed through the interiors of the wings such that the bolts protrude to the center towards the opposite wing (i.e., stop 208(1) and stop 208(2) are inserted through the outside of the left wing 202 and protrude towards the right wing 204, and stop 208(3) and stop 208(4) are inserted through the outside of the right wing 204 and protrude towards the left wing 202), and the bolts can be secured with a nut that has threading that matches the bolts. In some embodiments, the stops 208 can be a portion of the single unitary main frame 200, such as stops 208 cast in the single metal cast piece comprising the main frame 200. In some embodiments, the stops 208 can be installed on the front of the motor plate 300 (e.g., a stop near each corner of the motor plate 300 such that there are an upper left and right stop and a lower left and right stop) and the stop blocks 304 can be installed on the inside of the left wing 202 and the right wing 204 (e.g., a stop block positioned on the inside of each wing between the stops on the motor plate 300).

The stopping mechanism comprising the stop blocks 304 and the stops 208 can prevent the motor plate 300 from disengaging from the main frame 200 in an upward and a downward direction when the stop blocks 304 contact the stops 208. The motor plate 300, which is inserted in the slider rods 302 that are inserted in the channels of the wings of the main frame 200, can be positioned such that the stop blocks 304 of the motor plate 300 are positioned below the stops 208 protruding from the top of the wings of the main frame 200 to prevent the motor plate 300 from disengaging from the main frame 200 in an upward direction, and above the stops 208 protruding from the bottom of the wings of the main frame 200 to prevent the motor plate 300 from disengaging from the main frame 200 in a downward direction. For example, stop 208(1) can be positioned above stop block 304(1) and stop 208(3) can be positioned above stop block 304(2) so that stop block 304(1) will contact stop 208(1) and stop block 304(2) will contact stop 208(3) when the motor plate 300 moves upward, and stop 208(2) can be positioned below stop block 304(1) and stop 208(4) can be positioned below stop block 304(2) so that stop block 304(1) will contact stop 208(2) and stop block 304(2) will contact stop 208(4) when the motor plate 300 moves downward. The length of the stop blocks 304 protruding from the motor plate 300 is greater than the depth of where the stops 208 are located on the wings and the length of the stops 208 protruding from the wings is at least the depth of where the stop blocks 304 are located on the motor plate 300 so that the stop blocks 304 will contact the stops 208 to stop an upward and a downward motion of the motor plate 300. Therefore, the motor plate 300 with the outboard motor attached is prevented from moving further upward or downward completely out of the main frame 200. For example, if the actuator 216 fails causing the motor plate 300 with the stop blocks 304 to move upward or downward, the stop blocks 304 will contact the stops 208 protruding from the wings of the main frame 200 to prevent the motor plate 300, and thus the motor attached to the motor plate 300, from disengaging completely from the main frame 200 of the jack plate assembly 100.

Although it is preferred to include at least two stops and two stop blocks in the jack plate assembly 100 for a safe stopping mechanism, in some embodiments, the jack plate assembly 100 may include one stop and one stop block to act as a stopping mechanism. For example, the main frame 200 may include stop 208(2) installed inside the left wing 202 and the motor plate 300 may include stop block 304(1) installed on the bottom left portion of the front of the motor plate 300 to stop the motor plate 300, and therefore the motor attached to the motor plate 300, from moving downward and disengaging from the main frame 200 of the jack plate assembly 100.

In some embodiments, the slider rods 302 can be cylindrical rods with an enlarged circumference at the top and/or bottom of the slider rods 302 to form a lip or ledge that acts as a stop. For instance, as the slider rods 302 move downward in the channels of the wings, the enlarged lip on the top of the slider rods 302 will not fit in the channels and thus the motor plate 300 attached to the slider rods 302 cannot disengaged from the jack plate assembly 100.

The transom segment 206 of the main frame 200 can include an actuator bracket 210 for connecting an actuator 216 (e.g., hydraulics) for an outboard motor. The actuator bracket 210 can be included in the single piece that comprises the unitary main frame 200, rather than the actuator bracket 210 being a separate piece that needs to be attached to the main frame 200. The motor plate 300 can also include an actuator bracket 306 attached to the motor plate 300 or included in a single piece motor plate (e.g., the motor plate 300 is a single metal cast piece or a single extruded piece of metal comprising the actuator bracket 306 and/or the stop blocks 304) for connecting the actuator 216. The actuator bracket 210 and the actuator bracket 306 can be used in combination to connect the actuator 216 (e.g., hydraulics) in the space between the main frame 200 and the motor plate 300 to move the motor that is attached to the motor plate 300. If the hydraulics fail, and the slider rods 302 and the motor plate 300 begin to slide downwards in the channels of the wings, the stop blocks 304 will contact the stops 208 to prevent the motor plate 300, and thus the motor, from completely disengaging from the jack plate assembly 100.

The improved stopping mechanisms can be used with the unitary style discussed herein, as well as used with the other traditional, multi-piece jack plate designs. For instance, in another embodiment, the left wing 202, the right wing 204, and a transom bracket may be three separate pieces that are affixed to each other to comprise the main frame 200. In this implementation, the stopping mechanism comprising the stop blocks 304 and the stops 208 can be used to prevent the motor plate 300 from disengaging from the jack plate assembly 100. For example, stop 208(1) and/or stop 208(2) can be attached to the left wing 202 and stop 208(3) and/or stop 208(4) can be attached to the right wing 204. The left wing 202 with stop 208(1) and/or stop 208(2) and the right wing 204 with stop 208(3) and/or stop 208(4) can be joined with the transom bracket between them (e.g., with bolts, screws, welding, etc.). The stop blocks 304 can be affixed to the motor plate 300 above at least two of the stops on opposite wings to prevent the motor plate 300 from disengaging from the main frame 200 (i.e., the left wing 202 and the right wing 204 joined by the transom bracket) in a downward direction when the stop blocks 304 contact the stops 208.

FIG. 1B is a rear view of a jack plate assembly according to an example embodiment of the present disclosure. In the example of FIG. 1B, the jack plate assembly 100 includes the main frame 200 and the back of the motor plate 300 where an outboard motor can be attached. The tops of the bolts that comprise the stop 208(1) and the stop 208(2) and are inserted through the left wing 202 are visible in the example of FIG. 1B. Additionally, the tops of the bolts that comprise the stop block 304(1) and the stop block 304(2) and are inserted through the back of the motor plate 300 into the stop blocks 304 are visible. In the example of FIG. 1B, the actuator bracket 306 for connecting an actuator 216 can be attached to the motor plate 300 with two bolts inserted from the back of the motor plate 300, where the tops of the bolts are visible, through the actuator bracket 306 and each bolt is secured with a nut.

FIG. 1C is a cross-section view of a jack plate assembly according to an example embodiment of the present disclosure. FIG. 1C illustrates how the stopping mechanism stops the motor plate 300 from disengaging from the main frame 200 of the jack plate assembly 100. In the example of FIG. 1C, the jack plate assembly 100 includes the motor plate 300 and a vertical cross-section of the main frame 200 through the left wing 202 and the right wing 204 such that the stop blocks 304 engaging the stops 208 are visible. The first stop block 304(1) is positioned above the second stop 208(2) and the second stop block 304(2) is positioned above the fourth stop 208(4) to prevent the motor plate 300 from disengaging from the main frame 200 in a downward direction when the stop blocks 304 contact stop 208(1) and stop 208(2). For example, an outboard motor can be attached to the back of the motor plate 300 and an actuator 216 for the motor can be attached to the actuator bracket 210 and the actuator bracket 306. The movement of the motor can be controlled by a boater and the motor can move up and down via the slider rods 302 attached to the motor plate 300 moving vertically in the channels of the left wing 202 and the right wing 204. The motor can be moved vertically in the channels until the stop blocks 304 contact the stops 208. Thus, the motor plate 300 and motor are stopped from disengaging from the main frame 200, such as by an actuator 216 failure that causes the motor plate 300 to move downward.

In another embodiment, a cable 218 may be attached to a bolt 220 inserted through the actuator bracket 306 and the actuator 216. For instance, the cable 218 may have a loop at the top and the bolt 220 can be inserted through the loop at the top of the cable 218, then a washer 222 and nut 224 can be placed over the bolt 220 to hold the cable 218 in place. In some examples, the nut 224 or another device to hold the cable 218 in place can be used with or without the washer 222. The cable 218 is long enough to reach the actuator bracket 210 below the actuator 216. The cable 218 can have a loop at the bottom for a bolt to be inserted through the actuator bracket 210 and the loop at the bottom of the cable 218, then a washer and nut assembly 226 similar to the washer 222 and nut 224 at the actuator bracket 306 can be placed over the bolt to hold the cable 218 in place at the actuator bracket 210. The cable 218 can have a cable sleeve at each end to hold each loop in place. The cable 218, once attached to the actuator bracket 306 and the actuator bracket 210, may be placed alongside the actuator 216 or behind the actuator 216. The length of the cable 218 is long enough to allow the motor plate 300 to move vertically, but short enough to allow the motor plate 300 to move vertically without disengaging from the main frame 200.

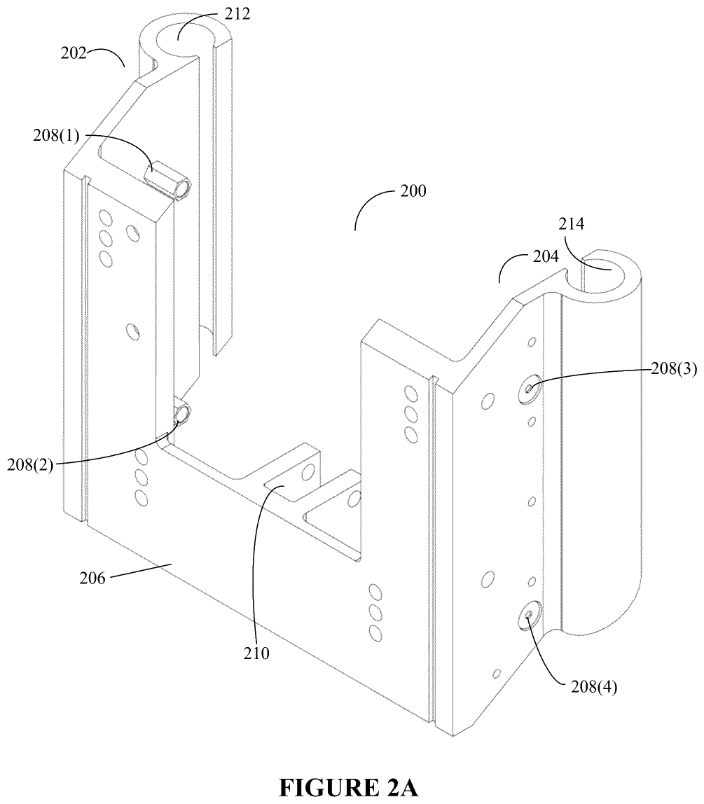

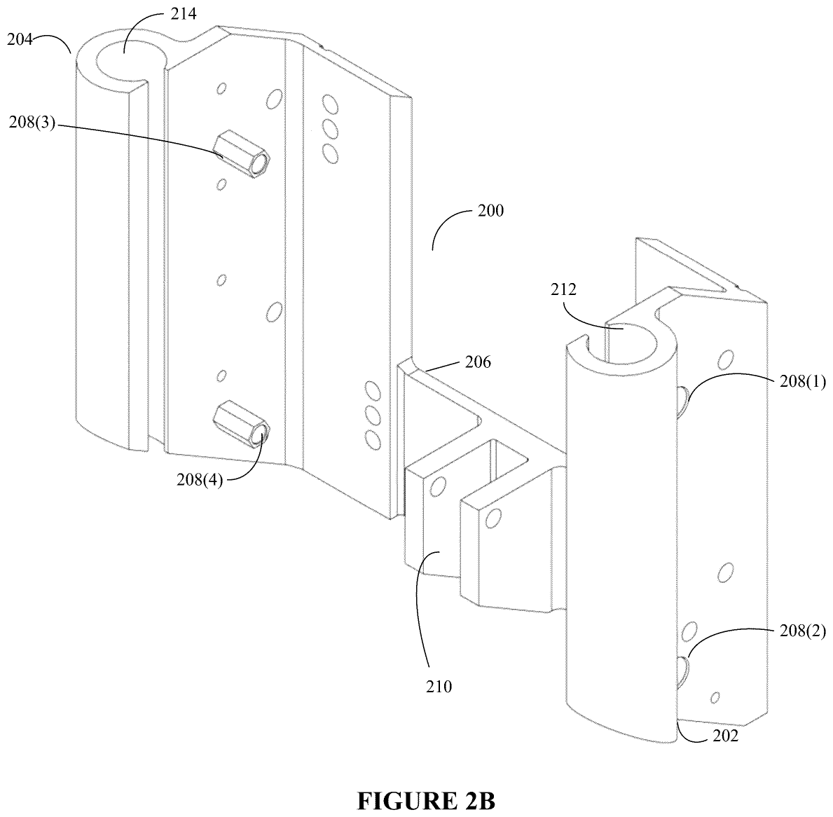

FIG. 2A is a front view of a unitary main frame of a jack plate assembly according to an example embodiment of the present disclosure. In the example of FIG. 2A, the unitary main frame 200 component of the jack plate assembly 100 is a single metal cast piece including the left wing 202, the right wing 204, the transom segment 206, and the actuator bracket 210. The left wing 202 can include the C-shaped channel 212 for the slider rod 302(1) (not illustrated) to be inserted and the right wing 204 can include the C-shaped channel 214 for the slider rod 302(2) (not illustrated) to be inserted. The C-shaped channels can also be formed in the single metal cast piece. Stop 208(1) and stop 208(2) can be attached to the left wing 202 with a bolt inserted through a hole on the outside of the left wing 202 where the bolt is longer than the thickness of the left wing 202 and secured with a nut such that the stops (i.e., the bolts) protrude out of the left wing 202 and inward towards the right wing 204. The tops of the bolts that comprise the stop 208(3) and the stop 208(4) and are inserted through the right wing 204 are visible in the example of FIG. 2A.

FIG. 2B is a rear view of a unitary main frame of a jack plate assembly according to an example embodiment of the present disclosure. In the example of FIG. 2B, the unitary main frame 200 component of the jack plate assembly 100 is a single metal cast piece including the left wing 202, the right wing 204, the transom segment 206, and the actuator bracket 210. The actuator bracket 210 is visible as being a portion of the single metal cast piece on the rear side of the transom segment 206. Stop 208(3) and stop 208(4) are attached to the right wing 204 with a bolt inserted through a hole on the outside of the right wing 204 where the bolt is longer than the thickness of the right wing 204 and secured with a nut such that the stops (i.e., the bolts) protrude out of the right wing 204 and inward towards the left wing 202. The tops of the bolts that comprise the stop 208(1) and the stop 208(2) and are inserted through the left wing 202 are visible in the example of FIG. 2B.

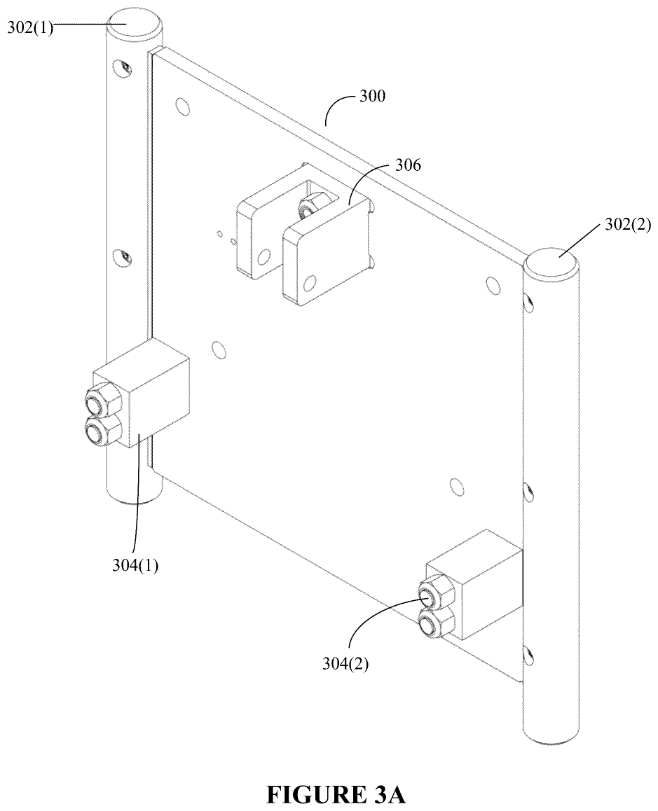

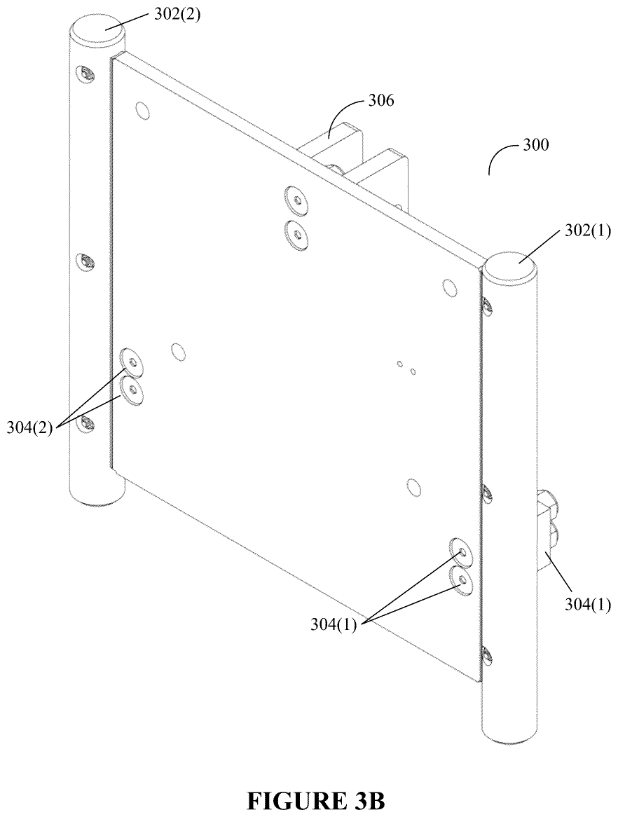

FIG. 3A is a front view of a motor plate of a jack plate assembly according to an example embodiment of the present disclosure. In the example of FIG. 3A, the front of the motor plate 300 component of the jack plate assembly 100 is viewed as detached from the main frame 200 of the jack plate assembly 100. The slider rods 302 can each include a vertical recess on one side to allow the motor plate 300 to be inserted into each slider rod. The motor plate 300 can have a left edge and a right edge that each have a vertical recess to allow the left and right edges of the motor plate 300 to be inserted into the slider rods 302. The slider rod 302(1) with the motor plate 300 attached can then be inserted into the C-shaped channel 212 of the left wing 202 of the main frame 200 and the slider rod 302(2) with the motor plate 300 attached can then be inserted into the C-shaped channel 214 of the right wing 204. In some examples, the motor plate 300 can be inserted into the slider rods 302, and bolts (e.g., three screws each secured with a nut on each of the slider rods 302) can secure the motor plate 300 inside the slider rods 302. In the example of FIG. 3A, the stop blocks 304 are rectangular blocks of metal secured to the motor plate 300 with two threaded bolts inserted from the rear of the motor plate 300 through threaded holes in the stop blocks 304 and secured on the other side of the stop blocks 304 with nuts that have threading that matches the bolts. The motor plate 300 can also include an actuator bracket 306 attached to the motor plate 300 for connecting the actuator 216. In some examples, the actuator bracket 306 can be attached to the motor plate 300 with two threaded bolts inserted from the rear of the motor plate 300 through the actuator bracket 306 and secured on the other side with nuts that have threading that matches the bolts.

FIG. 3B is a rear view of a motor plate of a jack plate assembly according to an example embodiment of the present disclosure. In the example of FIG. 3B, the back of the motor plate 300 component of the jack plate assembly 100 is viewed as detached from the main frame 200 of the jack plate assembly 100. An outboard motor can be attached to the rear of the motor plate 300 visible in FIG. 3B. In the example of FIG. 3B, the tops of the two bolts that secure the stop block 304(1) on the motor plate 300 and the tops of the two bolts that secure the stop block 304(2) on the motor plate 300, as well as holes for bolts used to attach an outboard motor to the motor plate 300, are visible.

The presently disclosed assemblies have a wide application anywhere in the industry where a jack plate with a stopping mechanism is needed. One particularly important application for the assemblies described herein relates to a jack plate that is attached to the transom of a boat with the stopping mechanism to stop the motor attached to the motor plate from falling out the bottom of the jack plate assembly. However, the assemblies described above could be utilized in other contexts.

Those skilled in the art will recognize improvements and modifications to the preferred embodiments of the present disclosure. All such improvements and modifications are considered within the scope of the concepts disclosed herein and the claims that follow.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

What is claimed is:

1. A jack plate, comprising:
a main frame comprising a left wing, a right wing, and a transom segment between the left wing and the right wing, wherein the left wing and the right wing each include a channel configured for inserting a slider rod, and wherein the transom segment is configured to attach to a boat transom;
a motor plate positioned between the left wing and the right wing and configured for attaching a motor;
a first stop block configured to attach to the motor plate and a second stop block configured to attach to the motor plate, wherein the first stop block and the second stop block protrude externally from the motor plate; and
a first stop configured to attach inside the left wing and a second stop configured to attach inside the right wing, wherein the first stop protrudes externally and inward from the left wing and the second stop protrudes externally and inward from the right wing, and wherein the first stop is positioned below the first stop block and the second stop is positioned below the second stop block.

2. The jack plate of claim 1, wherein the main frame comprises a single metal piece.

3. The jack plate of claim 1, wherein the first stop comprises a first bolt screwed through the left wing such that the first bolt protrudes towards the right wing, wherein the second stop comprises a second bolt screwed through the right wing such that the second bolt protrudes towards the left wing, and wherein the first bolt and the second bolt are each threaded and secured with a nut comprising threading that matches the first bolt and the second bolt.

4. The jack plate of claim 1, wherein the first stop block is attached to the motor plate with at least one bolt secured with a nut through the first stop block and the motor plate, and wherein the second stop block is attached to the motor plate with at least one bolt secured with a nut through the second stop block and the motor plate.

5. The jack plate of claim 1, wherein the first stop and the second stop prevent the motor plate from disengaging from the main frame in a downward direction when the first stop block contacts the first stop and the second stop block contacts the second stop.

6. The jack plate of claim 1, wherein each slider rod is configured to move vertically in each channel.

7. The jack plate of claim 1, wherein each channel configured for inserting a slider rod is a C-shaped channel.

8. The jack plate of claim 1, wherein each channel configured for inserting a slider rod is formed in the main frame.

9. The jack plate of claim 1, wherein the slider rod comprises a cylindrical rod of a singular circumference.

10. The jack plate of claim 1, wherein the slider rod includes a vertical recess for inserting the motor plate between the left wing and the right wing.

11. The jack plate of claim 1, wherein the motor plate has a vertical recess on each vertical side for inserting each vertical side of the motor plate into each slider rod.

12. The jack plate of claim 1, wherein the transom segment of the main frame includes an actuator bracket.

13. The jack plate of claim 12, wherein the main frame comprises a single metal cast piece including the actuator bracket.

14. The jack plate of claim 1, wherein the main frame is secured to the boat transom via the transom segment.

15. The jack plate of claim 1, further comprising hydraulics positioned between the main frame and the motor plate and configured to move the motor.

16. A jack plate, comprising:
a first stop block attached to a motor plate and a second stop block attached to the motor plate, wherein the first stop block and the second stop block protrude externally from the motor plate; and
a first stop attached inside a left wing of the jack plate and a second stop attached inside a right wing of the jack plate, wherein the first stop protrudes externally and inward from the left wing and the second stop protrudes externally and inward from the right wing, and wherein the first stop is positioned below the first stop block and the second stop is positioned below the second stop block.

17. The jack plate of claim 16, wherein the first stop comprises a first bolt screwed through the left wing such that the first bolt protrudes towards the right wing, wherein the second stop comprises a second bolt screwed through the right wing such that the second bolt protrudes towards the left wing, and wherein the first bolt and the second bolt are each threaded and secured with a nut comprising threading that matches the first bolt and the second bolt.

18. The jack plate of claim 16, wherein the first stop block is attached to the motor plate with at least one bolt secured with a nut through the first stop block and the motor plate, and wherein the second stop block is attached to the motor plate with at least one bolt secured with a nut through the second stop block and the motor plate.

19. The jack plate of claim 16, wherein the first stop and the second stop prevent the motor plate from disengaging from the jack plate in a downward direction when the first stop block contacts the first stop and the second stop block contacts the second stop.

20. A jack plate, comprising:
a main frame comprising a left wing, a right wing, a transom segment between the left wing and the right wing, and an actuator bracket, wherein the left wing and the right wing each include a C-shaped channel configured for inserting a slider rod, the left wing and the right wing are each configured for a stopping mechanism, the transom segment is configured to attach to a boat transom, and the main frame comprises a single metal piece.
